(19) United States
(12) Patent Application Publication
(10) Pub. No.: US 2018/0137768 A1
(43) Pub. Date: May 17, 2018

(54) VIRTUAL ACADEMIC CURRICULUM CONFIGURATOR

(71) Applicant: International Business Machines Corporation, Armonk, NY (US)

(72) Inventor: Eric V. Kline, Rochester, MN (US)

(21) Appl. No.: 15/351,924

(22) Filed: Nov. 15, 2016

(51) Int. Cl. G09B 7/00

(52) U.S. Cl. CPC G09B 7/00

(57) ABSTRACT

Embodiments include method, systems and computer program products for virtual academic curriculum configurator. In some embodiments, data from a plurality of tests for a student may be obtained. Each test of the plurality of tests may include questions of different levels of academic tension. Each test of the plurality of tests may be indicative of academic performance for the student. The data obtained from the plurality of tests may be regressed against the different levels of academic tension. An academic performance index (API) may be generated using the regressed data obtained from the plurality of tests. Curriculum content may be identified using the API. Delivery of the identified curriculum content to a student device may be facilitated.

### BACKGROUND

The present disclosure relates to data processing, and more specifically, to methods, systems and computer program products for a virtual academic curriculum configurator.

The education of multiple children in a single environment may prove to be challenging as children have different learning styles and often there are multiple levels of academic performance in a single classroom. Often, teachers must teach at a very high level, as there may be students at several different levels on an academic spectrum. Such an approach makes it difficult for each child to reach their optimal academic performance and thus may prevent a student from being challenged appropriately at their respective academic levels. Rather, some students may not be challenged at all, while others are too challenged. Either case may result in discouraged students who cannot further their academic progress without some sort of intervention.

### SUMMARY

In accordance with an embodiment, a method for a virtual academic curriculum configurator is provided. The method may include obtaining data from a plurality of tests for a student, wherein each test of the plurality of tests comprises questions of different levels of academic tension and wherein each test of the plurality of tests is indicative of academic performance for the student; regressing the data obtained from the plurality of tests against the different levels of academic tension; generating an academic performance index (API) using the regressed data obtained from the plurality of tests; identifying curriculum content using the API; and facilitating delivery of the identified curriculum content to a student device.

In another embodiment, a computer program product may comprise a non-transitory storage medium readable by a processing circuit that may store instructions for execution by the processing circuit for performing a method that may include: obtaining data from a plurality of tests for a student, wherein each test of the plurality of tests comprises questions of different levels of academic tension and wherein each test of the plurality of tests is indicative of academic performance for the student; regressing the data obtained from the plurality of tests against the different levels of academic tension; generating an academic performance index (API) using the regressed data obtained from the plurality of tests; identifying curriculum content using the API; and facilitating delivery of the identified curriculum content to a student device.

In another embodiment, a system may include a processor in communication with one or more types of memory. The processor may be configured to obtain data from a plurality of tests for a student, wherein each test of the plurality of tests comprises questions of different levels of academic tension and wherein each test of the plurality of tests is indicative of academic performance for the student; regress the data obtained from the plurality of tests against the different levels of academic tension; generate an academic performance index (API) using the regressed data obtained from the plurality of tests; identifying curriculum content using the API; and facilitate delivery of the identified curriculum content to a student device.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment; and

FIG. 3 is a flow diagram of a method for a virtual academic curriculum configurator in accordance with an exemplary embodiment.

### DETAILED DESCRIPTION

In accordance with exemplary embodiments of the disclosure, methods, systems and computer program products for a virtual academic curriculum configurator (ACC) are provided. The systems and methods described herein are directed to assessing the current cognitive capabilities and/or academic performance level of students in one or more subjects, yielding an Academic Performance Index (API) for that student in that specific subject. The ACC may then adjust the nominal curriculum for that student in that specific subject based on the student's API, so that the optimum difficulty level can be maintained for the student to maximize learning.

When served individually and independently for each student in a class, the ACC would permit the teacher enhanced flexibility to teach asynchronously (e.g., at a challenging level for students with higher APIs, and at a more modest level for students with lower APIs), since the ACC modifies the nominal curriculum for each student independently. That is, the teacher can teach the whole class at some level (e.g., average level of the class), and the ACC compensates for the outliers in both direction by adding more difficult materials for students with higher APIs and moderate materials for students with lower APIs.

The methods and systems described herein are directed to determining, for each student, which academic tension maximizes student academic performance. Academic tension is the delta or difference between a current performance level of a student and the curriculum content presented to the student. A zero academic tension indicates that the material or curriculum is at the current level of the student. A negative tension indicates that the curriculum is too easy for the student and does not challenge the student. A positive tension indicates that the material is beyond the student's current performance level.

Academic tension may be adjusted for a student (and subject) to yield maximum achievement. The way in which a student's optimal academic tension is determined is by regressing the student's performance in a given subject at multiple levels of academic tension (e.g., three to five levels) over some time-frame (e.g., three different dates), which would yield a statistically valid, time-sensitive model of the student's academic performance as a function of academic tension.

For example, some student may thrive under high academic tension, thus for this type of student, more challenging content curriculum is identified and delivered to the student. The virtual academic curriculum configurator may provide individualized variable academic tensioning for students for maximizing academic performance. The virtual academic curriculum configurator may generate an individualized academic performance index for each student. The academic performance index may be used to identify curriculum content to be delivered to the student. In some embodiments, other factors, such as teacher input (e.g., aggressive or liberal gradient) may be used with the academic performance index to identify the appropriate curriculum content.

In some embodiments, to determine whether a particular student performs better with higher or lower academic tensioning, the virtual academic curriculum configurator varies the degree (or magnitude) of academic tension over multiple test events and regresses the student's optimal learning verses academic tension. Once regressed, the academic curriculum configurator may utilize an optimal academic tension for the student for some period of time (e.g., a semester, or a year, or based on teacher's policy, etc.). Additionally, the academic curriculum configurator may periodically vary academic tension in order to routinely monitor and evaluate the progress of the student.

In some embodiments, the academic curriculum configurator may provide asynchronous (e.g., dynamic) curriculum configured specifically by subject for each student in a classroom. The content may be seamlessly delivered with minimal student disruption/competitiveness, as each student in the classroom may receive content of varying levels on their student device. The academic curriculum configurator may asynchronously and dynamically deliver curriculum configured specifically by subject for each student, which may provide optimum academic tension on an individual student basis to promote maximum academic achievement. Asynchronous academic tensioning for each student may be based on performance (e.g., program uses variable levels of academic tension and regresses against performance). In some embodiments, the virtual academic curriculum configurator may automatically vary the academic tension to test or verify academic performance and encourage the student to grow academically (e.g., programmed to increase or decrease academic tension on some basis to promote growth). In some embodiments, the academic curriculum configurator may asynchronously adjust the academic tensioning to continuously evaluate the student's optimal academic tensioning and keep student stimulated.

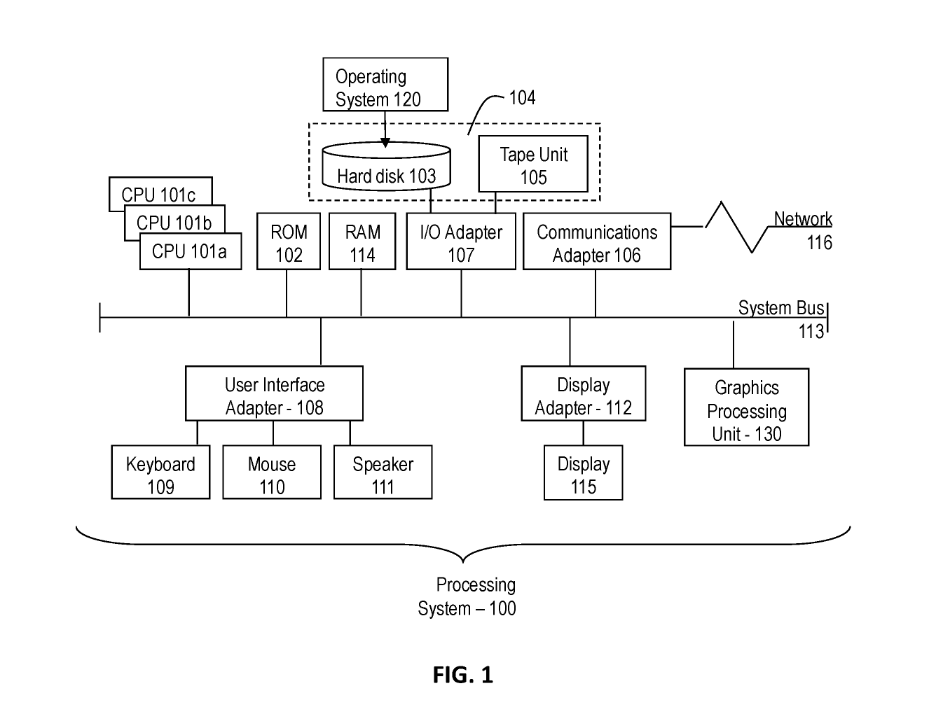

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A communications adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnect to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

In some embodiments, a nominal academic performance level by subject and grade (i.e., 4th grade social studies) and an individual student's API for that grade and subject may be used to either provide a nominal or adjusted curriculum in that subject to that specific student. The ACC may dynamically adjust the curriculum with more challenging or less challenging content depending on the student's API for that subject. The API may be calculated from specific or general testing. For example, it can be derived from a student's historical performance using a simple assignment, such as: A=1.25, B=1.10, C=1.00, D=0.80, F=0.79 (or lower). In another embodiment, specialized academic performance in a particular subject at a specific grade level can be done. Once an API is established for a given student for a given subject, I may be used by the ACC to adjust the delivered subject curriculum content to that student until such time that the student's API changes (e.g., which may drive a new adjustment factor) or the student changes grades. In some embodiments, the curriculum (e.g., for all subjects for which the invention is employed) is digital and served from a cloud or other server infrastructure, or in an alternative embodiment from a laptop, iPad/iPod, smartphone, etc. The ACC may then, based on the student's API for that specific subject, deliver to the student for his/her studying the adjusted subject curriculum.

The ACC may deliver subject curriculums over a wide variety of subjects. In some embodiments, the curriculum may be focused on classwork, homework, assignments, quizzes, tests, and/or graded or non-graded work. The ACC may allow students to work at academically more or less advanced grade levels for any given subject with discretion. The ACC may be programmably tuned to reinforce either maximum or “optimum” academic growth, knowledge mastery, or self-esteem of the student. The resolution of the curriculum delivery is adjustable, and could be adjusted by grade, subject, or teacher or student preference.

As an example, to program the ACC to maximally accelerate academic growth, the ACC may be instructed to stretch or challenge the student more frequently at an advanced level. Whereas, if the invention is programmed for maximum mastery of a subject, then it would be programmed to provide a greater variety of similar problems of same difficulty level. For students requiring self-esteem reinforcement, the ACC would be programmed to infrequently stretch or challenge, may even allow of regressive workloads.

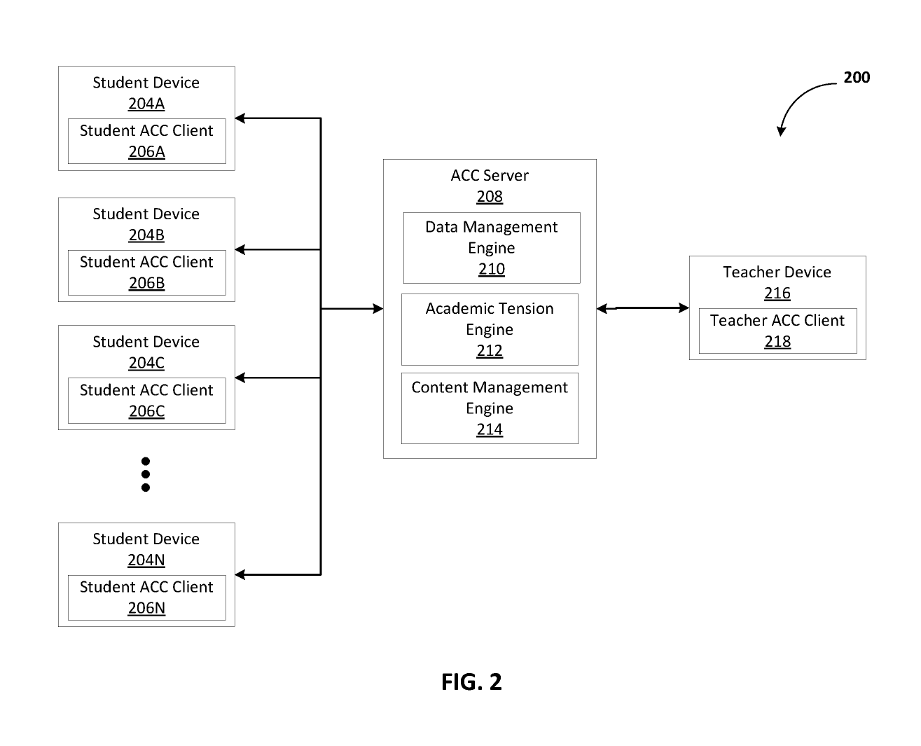

Referring now to FIG. 2, a computing system 200 in accordance with an embodiment is illustrated. As illustrated, the computing system 200 may include, but is not limited to, multiple student devices 204A, 204B, 204C, 204N (collectively referred to as 204), an academic curriculum configurator (ACC) server 208, and/or a teacher device 216. In some embodiments, student devices 204A, 204B, 204C, 204N may include a respective student academic curriculum content (ACC) client 206A, 206B, 206C, 206N (collectively referred to as 204). The ACC server 208 may include a data management engine 210, an academic tension engine 212, and/or a content management engine 214. The teacher device 216 may include a teacher ACC client 218. Although depicted as a client-server architecture, in some embodiments, the methods and systems described herein may be implemented using a cloud service architecture, where the student device 204 and the teacher device 216 communicate with functionality provided in a cloud computing environment.

In some embodiments, the student device 204 may be any type of computing device, such as a computer, laptop, tablet, smartphone, wearable computing device, server, etc. Each student device 204 may have a respective student ACC client 206. The student device 204 may communicate with one or more ACC servers 208. The student device may include a student ACC client 206. The student ACC client 206 may include computer-readable instructions that in response to execution by the processor(s) 101, cause operations to be performed including obtaining test data of a student (e.g., facilitating administration of a test to a student and collecting answers to test questions) and transmitting the test data to the ACC server 208 for analysis. The student device 204 may receive specially configured or retrieved content based on the student test results and present the content to the student associated with the student device 204.

In some embodiments, the ACC server 208 may be any type of computing device with network access, such as a computer, laptop, server, tablet, smartphone, wearable computing devices, or the like. The data management engine 210 may include computer-readable instructions that in response to execution by the processor(s) 101, cause operations to be performed including obtaining test data associated with each student in a classroom and tracking the different test data associated with each student. The data management engine 210 may communicate the test data to the academic tension engine 212 to generate an academic performance index (API) for the student. The data management engine 210 may track the different APIs associated with the student for different subjects, as well as the different APIs associated with the student over a period of time for a subject. The data management engine 210 may track and manage the content that was transmitted to the student and their interaction with the delivered content.

The academic tension engine 212 may include computer-readable instructions that in response to execution by the processor(s) 101, cause operations to be performed including analyzing the obtained data from a group of tests associated with a student. The academic tension engine 212 may, for example, apply a regressions model or an analysis of variance may be used by the academic tension engine 212 to generate the API for the student. An API may be an indication of an academic tensions for optimal academic learning for the student. A student may be associated with multiple APIs, for example, that may be associated with different subjects. For example, a student may have a high API for math while a more neutral or low API for English. The academic tension engine 212 may generate an API for a student and may transmit the API to the data management engine 210, which may communicate it to the content management engine 214 or directly to the content management engine 214.

The content management engine 214 may include computer-readable instructions that in response to execution by the processor(s) 101, cause operations to be performed including receiving an API for a student and obtaining the corresponding content for a specified subject for the received API. In some embodiments, content for different subjects may be stored in one or more datastores (not pictured). The content management engine 214 may use the API to identify a corresponding level of curriculum content, which may be retrieved from the one or more datastores. The content management engine 214 may transmit the retrieved curriculum content to the data management engine 214, which may facilitate transmission of the retrieved content to the respective student device 204. Examples of the different levels of an API and examples of corresponding content are depicted in Tables 1 and 2, below.

TABLE 1
Math Example

| Student | API | Content |
|---|---|---|
| Student 1 | 0.85 | 3 + X = 4; solve for X |
| Student 2 | 1.00 | 5X + 1 = 4; solve for X |
| Student 3 | 1.2 | P * Q − Q = 12, if P = 5, solve |
| | | for Q |

TABLE 2
English Example

| Student | API | Content |
|---|---|---|
| Student 1 | 0.80 | We spent the day selling |
| | | lemonade to our neighbors |
| | | in little plastic cups. |
| Student 2 | 1.00 | Slowly ascending the roller |
| | | coaster, the fairgrounds |
| | | below looked increasingly |
| | | small, like a miniature |
| | | model of itself. |
| Student 3 | 1.25 | With its pleated ribs that |
| | | expand and contract with |
| | | the availability of water, |
| | | extreme heat is no match |
| | | for the Saguaro cactus, |
| | | which can reach a height of |
| | | fifty feet. |

In some embodiments, the teacher device 216 may be any type of computing device, such as a computer, laptop, tablet, smartphone, wearable computing device, server, etc. Each teacher device 216 may have a respective teacher ACC client 218. The teacher device 216 may communicate with one or more ACC servers 208. The teacher device 216 may include a teacher ACC client 218. The teacher ACC client 218 may include computer-readable instructions that in response to execution by the processor(s) 101, cause operations to be performed including viewing test data for each student in their class, reviewing APIs associated with the students, and providing additional information (such as lenient or restrictive grading gradients or adjustment of APIs based on external factors). The teacher ACC client 218 may enable a teacher to monitor the progress of the students, review the different levels of content delivered to the students of the classroom, and the like.

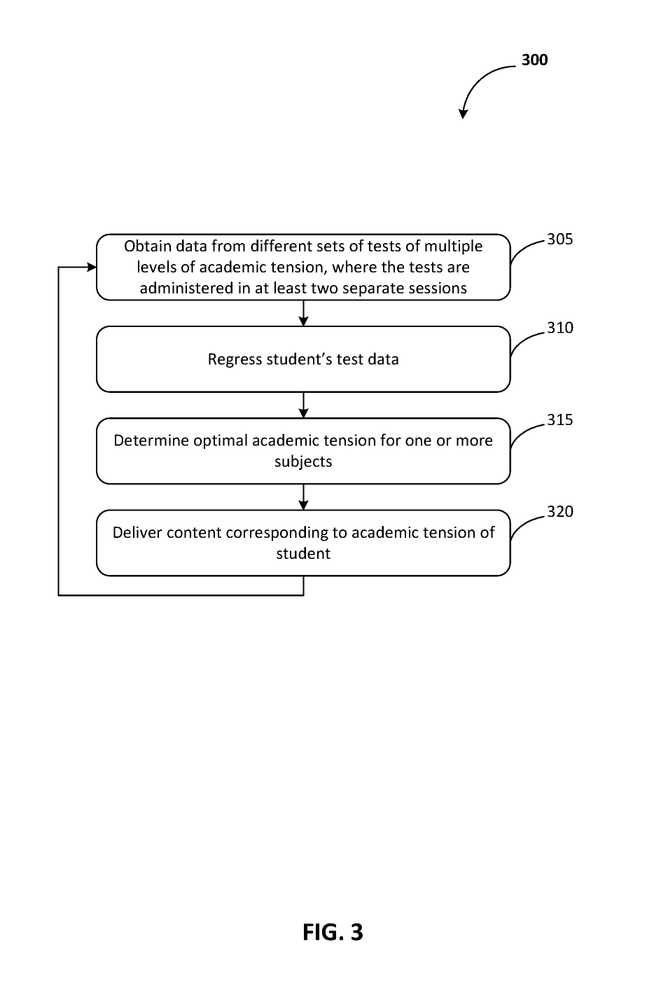

Now referring to FIG. 3, a flow diagram of a method 300 for a virtual academic curriculum configurator in accordance with an exemplary embodiment is depicted.

At block 305, data from tests of multiple levels of academic tension may be obtained. In some embodiments, the tests may be administered in at least two different sessions, as the response variable is the magnitude of the performance delta between the first and second tests. In some embodiments, administering the tests on different dates is necessary because the magnitude of the differences or deltas in the tests, which indicate academic performance, are regressed against the academic tension to obtain the API for that student for that subject.

Student ACC clients 206 may be used to administer tests to a classroom of students and collecting responses (e.g., test data) that are then transmitted to the ACC server 208. In some embodiments, the tests may include questions from a single subject or multiple subjects. The tests may include questions of varying academic tensions or difficulty. Tests may be administered at predetermined time intervals (e.g., weekly, monthly, etc.) or dates (e.g., beginning of semester, midway through semester, end of semester).

At block 310, the student's test data may be regressed or otherwise analyzed. In some embodiments, the data management engine 210 may make a determination as to whether there are sufficient sets of test data to be analyzed. In some embodiments, the data management engine 210 may require at least two different test data sets for each student in order to generate a statistically relevant API for the student. In some embodiments, the data management engine 210 may require three or more different test data sets, each administered at different times, to obtain more data points that may be used to measure the magnitude of the performance delta between the different test data sets to more accurately reflect the performance of a student. In some embodiments, the data management engine 210 may retrieve test data sets that were previously generated (e.g., earlier test administration from same grade or possibly an earlier grade).

The academic tension engine 212 may receive the test data sets associated with a student and may apply a regression algorithm or variance analysis. For example, as depicted in Table 3, a test may include questions for a single subject and have questions of differing academic tension (e.g. levels −2 to 2). A negative academic tension (e.g., level −2 or −1) or difficulty level may indicate that the curriculum or content is below a current academic performance level of a student, a neutral academic tension (e.g., level 0) may indicate that the curriculum or content is equal to the current academic performance level of a student, and a positive academic tension (e.g., level 1 or 2) may indicate that the curriculum or content is greater than the current academic performance level of a student. In Table 3, the “Level” column represents the academic tension and the columns labelled “Score 1”, “Score 2”, and “Score 3” represents academic performances of the student at three separate sessions. The columns labelled “Delta 1, 2” and “Delta 1, 3” indicate the magnitude of the differences or deltas in the tests. The column labelled “Delta 1, 2” illustrates the difference in score between the value in the column labeled “Score 1” and the value in the column labeled “Score 2” for that row. The column labelled “Delta 1, 3” illustrates the difference in score between the value in the column labeled “Score 1” and the value in the column labeled “Score 3” for that row. The “Delta 1, 2” and “Delta 1, 3” columns are regressed against the “Level” column to yield the API, which is the model that demonstrates the student's performance vs. academic tension. The academic tension engine may regress the test scores associated with the student (e.g., score 1, score 2, score 3) and calculate the difference in the test scores for each of the different levels of questions.

TABLE 3
Regression Model

| Subject | Level | Score 1 | Score 2 | Score 3 | Delta 1, 2 | Delta 1, 3 |
|---|---|---|---|---|---|---|
| History | −2 | 100 | 100 | 100 | 0% | 0% |
| History | −1 | 90 | 95 | 95 | 5% | 5% |
| History | 0 | 90 | 95 | 95 | 5% | 5% |
| History | 1 | 85 | 95 | 100 | 10% | 15% |
| History | 2 | 70 | 75 | 80 | 5% | 10% |

At block 315, an optimal academic tension for one or more subjects may be determined. Using the information obtained after the test data has been regressed (e.g., at block 310), the academic tension engine 212 may generate an API. The API may indicate an optimal academic tension for the student for maximizing their academic performance. The academic tension engine 212 may provide the API to the content management engine 214 and/or the data management engine 210.

At block 320, the content corresponding to the academic tension of the student may be delivered. The content management engine 214 may obtain or receive an API associated with a student and may identify or retrieve content associated with the API. In some embodiments, the curriculum content may be retrieved from one or more datastores. In some embodiments, the content may be transmitted to the data management engine 210. The data management engine 210 may facilitate transmission of the content to the respective student device 204 for consumption by the student.

In some embodiments, the data management engine 210 may generate a report for a teacher of one or more students. The report may include identifying information of the student, test data associated with the student, APIs associated with the student, and the like. In some embodiments, the report may include a current API for each enrolled subject. In some embodiments, the report may include a history of APIs for a single subject so that the student's progress may be monitored and validated. The report may include the curriculum content provided to the student.

In some embodiments, the method may proceed back to block 305, demonstrating the dynamic nature of the systems and methods described herein. Students may continue to be tested at predetermined time intervals (e.g., periodic time intervals or specified dates in an academic year). Based on the new testing, a student's APIs may be adjusted to account for any increase or decrease in performance level to ensure that the student is always at an optimal academic tension to encourage academic growth.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for a virtual academic curriculum configurator, the method comprising:
obtaining data from a plurality of tests for a student, wherein each test of the plurality of tests comprises questions of different levels of academic tension and wherein each test of the plurality of tests is indicative of academic performance for the student;
regressing the data obtained from the plurality of tests against the different levels of academic tension;
generating an academic performance index (API) using the regressed data obtained from the plurality of tests;
identifying curriculum content using the API; and
facilitating delivery of the identified curriculum content to a student device.

2. The computer-implemented method of claim 1, wherein each test of the plurality of tests is administered on a different date.

3. The computer-implemented method of claim 2, wherein each test comprises questions from a plurality of subjects.

4. The computer-implemented method of claim 1, wherein identifying curriculum content further comprises:
receiving information associated with the student from a teacher device; and
identifying curriculum content using the API and the information.

5. The computer-implemented method of claim 1, further comprising:
obtaining test data from a new test for the student;
regenerating the API using the test data;
identifying new curriculum content using the regenerated API; and
facilitating delivery of the new curriculum content to the student device.

6. The computer-implemented method of claim 1, further comprising:
administering each of the plurality of tests at a predetermined time interval.

7. The computer-implemented method of claim 1, further comprising:
generating a report reflecting student progress based on the plurality of tests, the API, and the curriculum content.

8. A computer program product comprising a non-transitory storage medium readable by a processing circuit and storing instructions for execution by the processing circuit for performing a method comprising:
obtaining data from a plurality of tests for a student, wherein each test of the plurality of tests comprises questions of different levels of academic tension and wherein each test of the plurality of tests is indicative of academic performance for the student;
regressing the data obtained from the plurality of tests against the different levels of academic tension;
generating an academic performance index (API) using the regressed data obtained from the plurality of tests;
identifying curriculum content using the API; and
facilitating delivery of the identified curriculum content to a student device.

9. The computer program product of claim 8, wherein each test of the plurality of tests is administered on a different date.

10. The computer program product of claim 9, wherein each test comprises questions from a plurality of subjects.

11. The computer program product of claim 8, wherein identifying curriculum content further comprises:
receiving information associated with the student from a teacher device; and
identifying curriculum content using the API and the information.

12. The computer program product of claim 8, the method further comprises:
obtaining test data from a new test for the student;
regenerating the API using the test data;
identifying new curriculum content using the regenerated API; and
facilitating delivery of the new curriculum content to the student device.

13. The computer program product of claim 8, the method further comprises:
administering each of the plurality of tests at a predetermined time interval.

14. The computer program product of claim 8, the method further comprises:
generating a report reflecting student progress based on the plurality of tests, the API, and the curriculum content.

15. A system, comprising:
a processor in communication with one or more types of memory, the processor configured to:
obtain data from a plurality of tests for a student, wherein each test of the plurality of tests comprises questions of different levels of academic tension and wherein each test of the plurality of tests is indicative of academic performance for the student;
regress the data obtained from the plurality of tests against the different levels of academic tension;
generate an academic performance index (API) using the regressed data obtained from the plurality of tests;
identify curriculum content using the API; and
facilitate delivery of the identified curriculum content to a student device.

16. The system of claim 15, wherein each test of the plurality of tests is administered on a different date.

17. The system of claim 16, wherein each test comprises questions from a plurality of subjects.

18. The system of claim 15, wherein, to identify the curriculum content, the processor is further configured to:
receive information associated with the student from a teacher device; and
identify curriculum content using the API and the information.

19. The system of claim 15, wherein the processor is further configured to:
obtain test data from a new test for the student;
regenerate the API using the test data;
identify new curriculum content using the regenerated API; and
facilitate delivery of the new curriculum content to the student device.

20. The system of claim 15, wherein the processor is further configured to:
administer each of the plurality of tests at a predetermined time interval.
